(19) United States
(12) Patent Application Publication
(10) Pub. No.: US 2016/0063515 A1
(43) Pub. Date: Mar. 3, 2016

(54) SYSTEMS AND METHODS FOR ANALYZING ONLINE SURVEY QUESTIONS

(71) Applicant: SURVEYMONKEY INC., Palo Alto, CA (US)

(72) Inventor: FEDOR N. DZEGILENKO, San Jose, CA (US)

(21) Appl. No.: 14/473,294

(22) Filed: Aug. 29, 2014

(51) Int. Cl. G06Q 30/02

(52) U.S. Cl. CPC G06Q 30/0201

(57) ABSTRACT

An electronic device-controlled method can include receiving responses to a question of an online survey, determining an average daily response for the question, and determining an upper confidence level and a lower confidence level for the question. A subsequent determination can be made as to whether the question is stable based on the average daily response and upper and lower confidence levels over a specified period of time.

### CROSS-REFERENCE TO RELATED APPLICATIONS

This application may be found to be related to U.S. patent application Ser. No. 13/966,829, titled SYSTEMS AND METHODS FOR ANALYZING ONLINE SURVEYS AND SURVEY CREATORS and filed on Aug. 14, 2013, the content of which is hereby incorporated by reference herein in its entirety.

### TECHNICAL FIELD

The technical field pertains generally to systems and methods for administering and managing online surveys and, more particularly, to creating, facilitating, and evaluating questions of such surveys by way of electronic devices such as personal computers and mobile electronic devices, e.g., smartphones and tablet computing devices.

### BACKGROUND

Online surveys have become increasingly valuable to individuals, companies, and virtually all types of organizations by enabling such entities to quickly and efficiently obtain various types of information from any number of target populations. Such information may include customer preferences, feedback on products and/or services, and customer service-related information. Companies may incorporate such information in making various business and/or strategic or otherwise tactical decisions, for example. Also, the continued prevalence of mobile electronic devices, such as smartphones and tablet devices, in today's society provides individuals and groups with even greater access to virtually every type of target populations for electronic surveys and other information-gathering mechanisms. Indeed, millions of people use the Internet or other networks on a regular—often daily—basis, both at home and at their workplace. Accordingly, there remains a need for further improvements in evaluating online survey questions, particularly with regard to their potential suitability for use in connection with various benchmarking functionalities.

### BRIEF DESCRIPTION OF THE DRAWINGS

FIG. 1 illustrates an example of a networked system in accordance with certain embodiments of the disclosed technology.

FIG. 2 illustrates an example of an electronic device in which certain aspects of various embodiments of the disclosed technology may be implemented.

FIG. 3 is a flowchart illustrating an example of a computer-controlled method in accordance with certain embodiments of the disclosed technology.

FIG. 4 illustrates an example of a graphical representation of a stable online survey question over a period of time in accordance with certain embodiments of the disclosed technology.

FIG. 5 illustrates an example of a graphical representation of an unstable online survey question over a period of time in accordance with certain embodiments of the disclosed technology.

FIG. 6 illustrates an example of a table representing information pertaining to results of an online survey question over a period of time in accordance with certain embodiments of the disclosed technology.

FIG. 7 illustrates an example of a table representing information pertaining to multiple online survey questions over corresponding periods of time in accordance with certain embodiments of the disclosed technology.

FIG. 8 illustrates an example of an online survey management and survey result evaluation system in accordance with certain embodiments of the disclosed technology.

### DETAILED DESCRIPTION

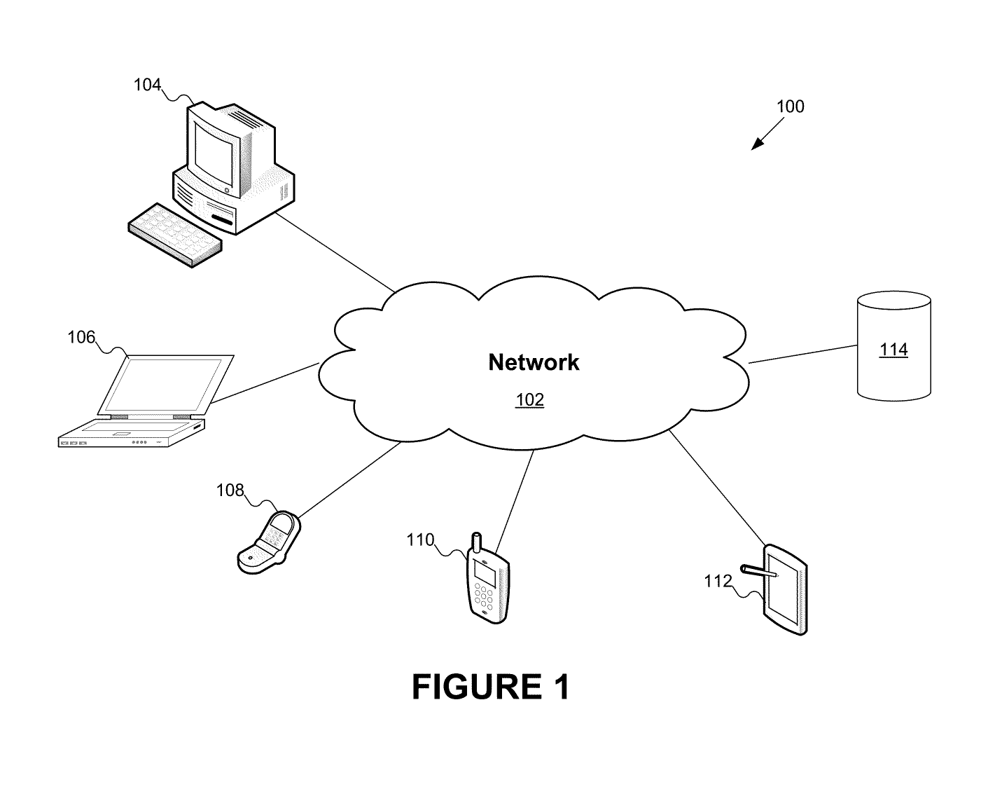

FIG. 1 illustrates an example of a networked system 100 in accordance with certain embodiments of the disclosed technology. In the example, the system 100 includes a network 102 such as the Internet, an intranet, a home network, a public network, or any other network suitable for implementing embodiments of the disclosed technology. In the example, personal computers 104 and 106 may connect to the network 102 to communicate with each other or with other devices connected to the network.

The system 100 also includes three mobile electronic devices 108-112. Two of the mobile electronic devices 108 and 110 are communications devices such as cellular telephones or smartphones. Another of the mobile devices 112 is a handheld computing device such as a personal digital assistant (PDA), tablet device, or other portable device. A storage device 114 may store some of all of the data that is accessed or otherwise used by any or all of the computers 104 and 106 and mobile electronic devices 108-112. The storage device 114 may be local or remote with regard to any or all of the computers 104 and 106 and mobile electronic devices 108-112.

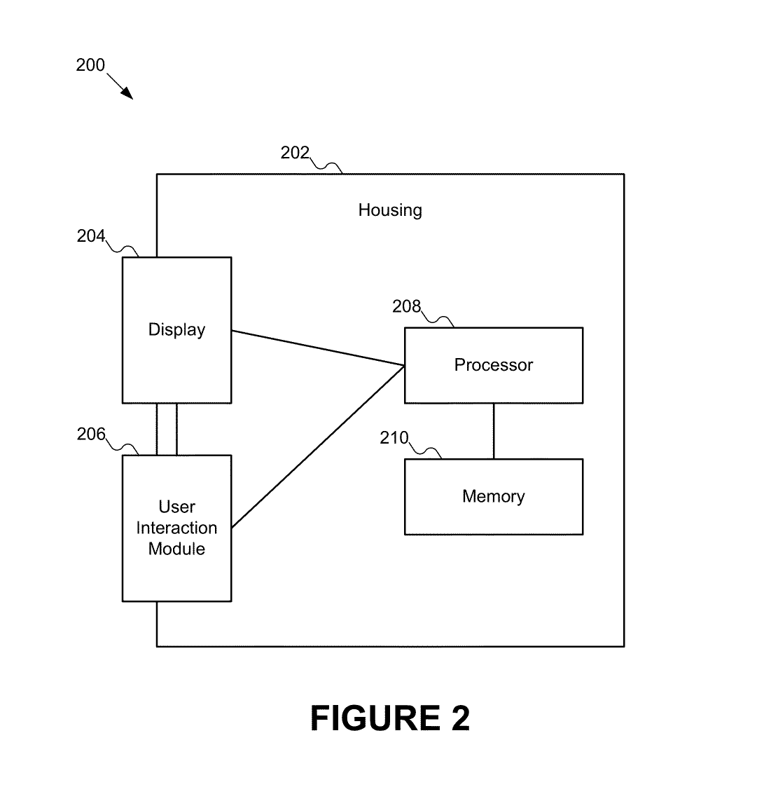

FIG. 2 illustrates an example of an electronic device 200, such as the devices 104-112 of the networked system 100 of FIG. 1, in which certain aspects of various embodiments of the disclosed technology may be implemented. The electronic device 200 may include, but is not limited to, a personal computing device such as a desktop or laptop computer, a mobile electronic device such as a PDA or tablet computing device, a mobile communications device such as a smartphone, an industry-specific machine such as a self-service kiosk or automated teller machine (ATM), or any other electronic device suitable for use in connection with certain embodiments of the disclosed technology.

In the example, the electronic device 200 includes a housing 202, a display 204 in association with the housing 202, a user interaction module 206 in association with the housing 202, a processor 208, and a memory 210. The user interaction module 206 may include a physical device, such as a keyboard, mouse, microphone, speaking, or any combination thereof, or a virtual device, such as a virtual keypad implemented within a touchscreen. The processor 208 may perform any of a number of various operations. The memory 210 may store information used by or resulting from processing performed by the processor 208.

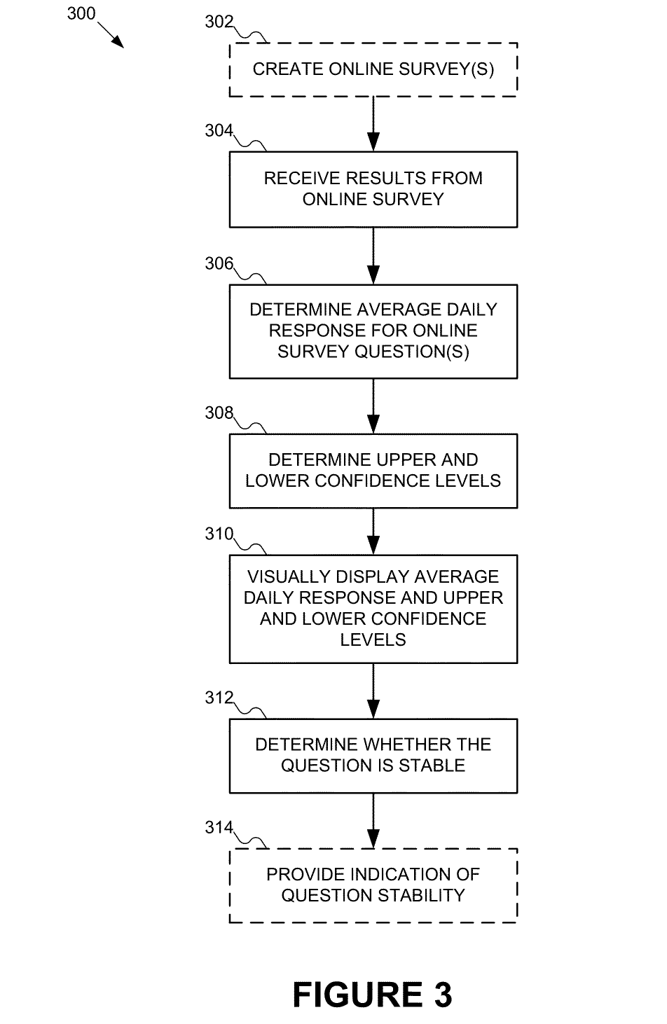

FIG. 3 is a flowchart illustrating an example of an electronic device-controlled method 300 in accordance with certain embodiments of the disclosed technology.

At 302, at least one online survey is created. In certain embodiments, one or more surveys that were previously created [by the same user or other users] may be used in addition to or in place of one or more newly-created surveys.

At 304, results corresponding to at least one question of an online survey—such as may have been created at 302—are received. For example, raw data may be received directly from survey takers that have at least partially taken the survey(s) that were created and/or selected at 302. The results may be received continuously (e.g., in real-time), at certain times (e.g., of certain days), after certain periods of time have passed since the last time results were received, in response to a user request, or any combination thereof.

At 306, an average daily response is determined for a certain question based on the results for that question from that day. That is, all of the responses [received at 304] for the question that were submitted on the day in question are averaged, thus resulting in the average daily response for that question for that day. It should be noted that, while the example uses days as the period of time, one having ordinary skill in the art will appreciate that virtually any period of time may be used (e.g., every minute, hourly, weekly, or monthly).

At 308, upper and lower confidence levels are determined based at least in part on the received results for the corresponding question. In addition, either or both of the upper and lower confidence levels may be determined based on any of a number of parameters using virtually any suitable technique. Also, either or both of the upper and lower confidence levels may be adjusted (e.g., in real-time or responsive to a certain event and/or passing of time) as more results for the question are received.

At 310, the average daily response [determined at 306] and upper and lower confidence levels [determined or adjusted at 308] may be visually presented to a user, e.g., by way of a monitor or other suitable electronic display. In certain embodiments, a graphing may be used to present such information.

At 312, a determination is made as to whether the question may be considered stable based on the average daily response [and upper/lower confidence levels] over a specified period of time, e.g., 60 days. An indication of this determination may be optionally provided (e.g., visually presented to a user) as indicated at 314. In certain embodiments, this indication may be used to determine suitability of the question with regard to benchmarking techniques such as those described in U.S. patent application Ser. No. 13/966,829, which is incorporated by reference herein.

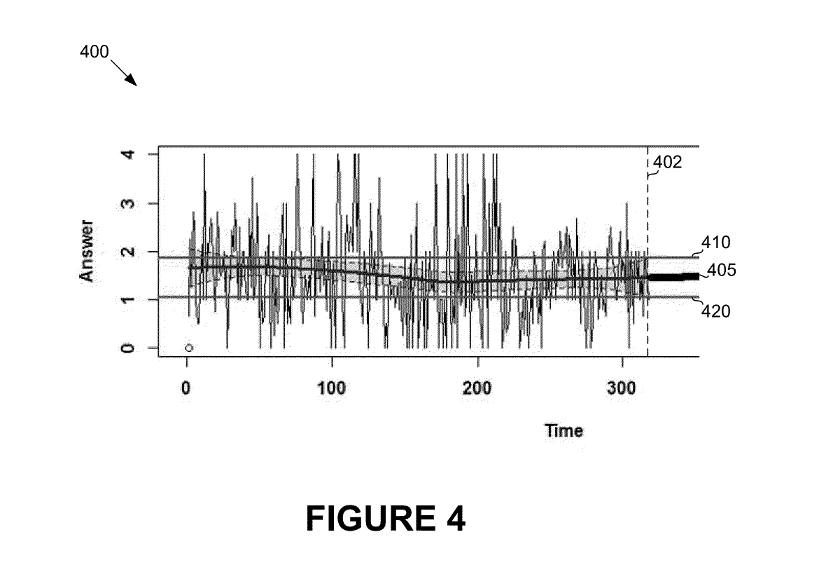

FIG. 4 illustrates an example of a graphical representation 400 of a stable online survey question over a period of time in accordance with certain embodiments of the disclosed technology. In the example, the x-axis represents time as measured in days and the y-axis represents all of the [numeric] answers to a first question of an online survey (here, integers ranging from zero to four). An average daily response line 405 represents a plotting of each determined average daily result over a period of time that currently spans approximately 320 days, as indicated by 402, as well as a projection of future average daily responses. In the example, the corresponding question of the online survey is deemed stable because the average daily response line 405 crosses neither an upper confidence level 410 nor a lower confidence level 420 and the period of time (here, approximately 320 days so far) exceeds a specified period of time (here, 60 days) and, further, a future projection of the average daily response line 405 still remains between the upper and lower confidence levels 410 and 420, respectively.

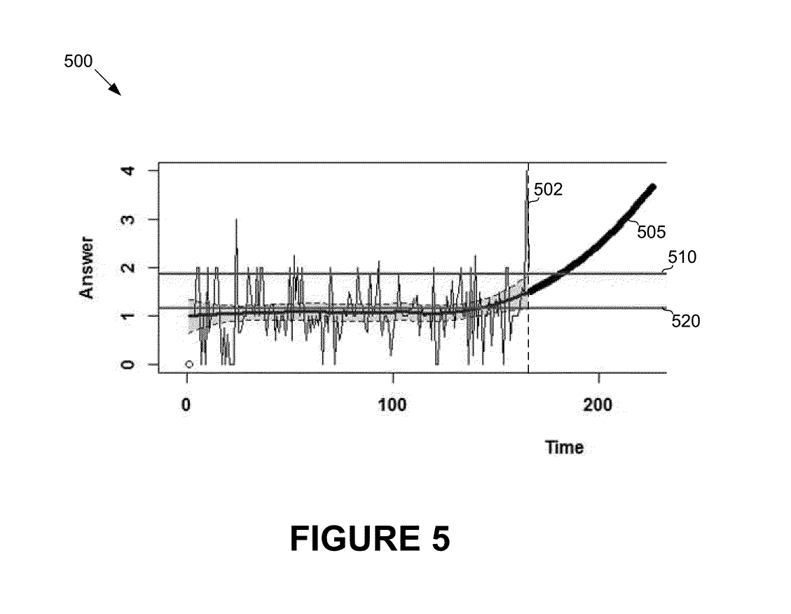

FIG. 5 illustrates an example of a graphical representation 500 of an unstable online survey question over a period of time in accordance with certain embodiments of the disclosed technology. As with the example illustrated by FIG. 4, the x-axis here represents time as measured in days and the y-axis represents all of the [numeric] answers to a first question of an online survey (again, integers ranging from zero to four). An average daily response line 505 represents a plotting of each determined average daily result over a period of time that currently spans approximately 175 days, as indicated by 502, as well as a projection of future average daily responses. In the example, the corresponding question of the online survey is deemed unstable because the average daily response line 505 is less than a lower confidence level 520 for the first 150 days or so and, while the average daily response line 505 does cross the lower confidence level 520 at one point (i.e., after approximately 150 days), the average daily response line 505 is projected to cross the upper confidence level 510 less than 50 days afterward.

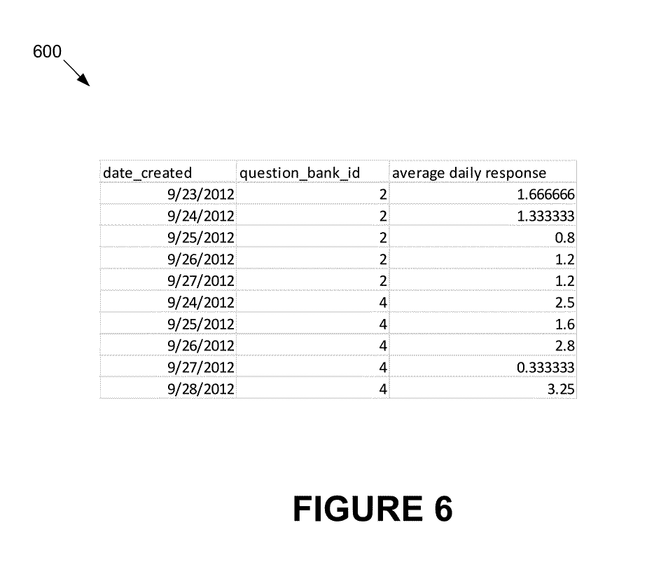

FIG. 6 illustrates an example of a table 600 representing information pertaining to results of an online survey question over a period of time in accordance with certain embodiments of the disclosed technology. In the example, two online survey questions (one identified by identifier 2 and the other identified by identifier 4) each have multiple average daily responses: from Sep. 23, 2012 through Sep. 27, 2012 for the first question (identifier 2) and from Sep. 24, 2012 through Sep. 28, 2012 for the second question (identifier 4). These average daily responses may be used in connection with determined upper and lower confidence levels to determine whether either question may be a good candidate for benchmarking techniques.

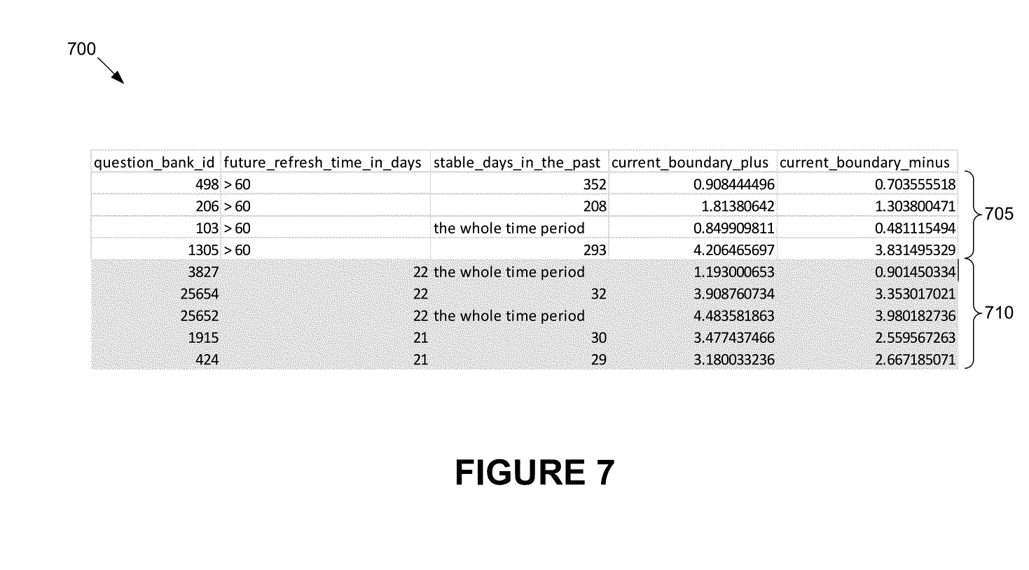

FIG. 7 illustrates an example of a table 700 representing information pertaining to multiple online survey questions over corresponding periods of time in accordance with certain embodiments of the disclosed technology. In the example, the table 700 includes a group of stable questions (as indicated by reference number 705) and a group of unstable questions (as indicated by reference number 710). Each of the stable questions 705 has not had an average daily result drop below a lower confidence level or exceed a higher confidence level for greater than the specified period of time (here, 60 days). In contrast, each of the unstable questions 710 has had an average daily result drop below a lower confidence level and/or exceed a higher confidence level within the specified period of time (here, 60 days).

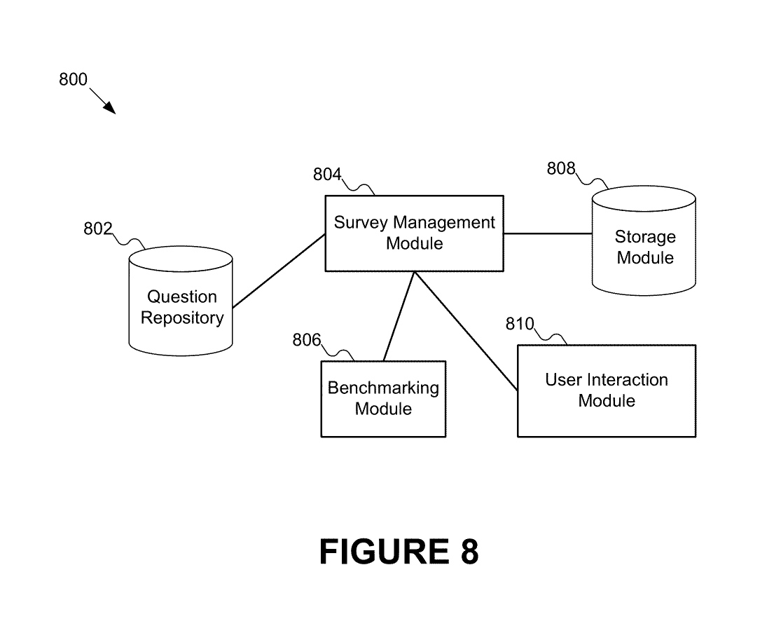

FIG. 8 illustrates an example of an online survey management and survey result evaluation system 800 in accordance with certain embodiments of the disclosed technology. In the example, the system 800 includes a question repository 802, also referred to herein as a question bank, that is configured to store multiple sets of questions, each set of questions including questions that have a superficial modifier portion, a semantic modifier portion, an open-ended modifier portion, or a combination thereof.

A survey management module 804 allows a user to select a set of questions from the question repository 802 for use as or otherwise with an online survey. The survey management module 804 may also provide semantic modifier options for each question having a semantic modifier portion.

A benchmarking module 806 may group questions and surveys by semantic modifiers and provide an analysis of the survey questions based on properties of the survey-creator and other, previously-created surveys by other survey-creators with different or similar properties as described herein.

A storage module 808 may be used to store results of the analysis. A user interaction module 810 may be used to control a user interface configured to provide a visual representation of results of the analysis. The user interaction module 810 may also adjust the visual representation of the results based on the user adjusting or otherwise altering the analysis. In such embodiments, the storage module 808 may also store the altered analysis or results thereof. In certain embodiments, a parsing module (not shown) may be used to identify semantic modifier portions within the selected set of questions.

Having described and illustrated the principles of the invention with reference to illustrated embodiments, it will be recognized that the illustrated embodiments may be modified in arrangement and detail without departing from such principles, and may be combined in any desired manner. And although the foregoing discussion has focused on particular embodiments, other configurations are contemplated. In particular, even though expressions such as “according to an embodiment of the invention” or the like are used herein, these phrases are meant to generally reference embodiment possibilities, and are not intended to limit the invention to particular embodiment configurations. As used herein, these terms may reference the same or different embodiments that are combinable into other embodiments.

Consequently, in view of the wide variety of permutations to the embodiments described herein, this detailed description and accompanying material is intended to be illustrative only, and should not be taken as limiting the scope of the invention. What is claimed as the invention, therefore, is all such modifications as may come within the scope and spirit of the following claims and equivalents thereto.

1. An electronic device-controlled method, comprising:
an electronic device receiving a plurality of responses to a first question of an online survey;
the electronic device determining a plurality of average daily responses for the first question of the online survey based on the plurality of received responses;
the electronic device determining an upper confidence level based on the plurality of received responses;
the electronic device determining a lower confidence level based on the plurality of received responses; and
the electronic device determining whether the first question of the online survey is stable based on the plurality of average daily responses in relation to the upper and lower confidence levels over a specified period of time.

2. The electronic device-controlled method of claim 1, wherein the electronic device is a mobile electronic device.

3. The electronic device-controlled method of claim 2, wherein the mobile electronic device is a smartphone or tablet computing device.

4. The electronic device-controlled method of claim 1, further comprising the electronic device providing an indication as to whether the first question is stable based on the determination as to whether the first question of the online survey is stable.

5. The electronic device-controlled method of claim 1, further comprising the electronic device receiving additional responses to the first question of the online survey.

6. The electronic device-controlled method of claim 5, further comprising the electronic device determining at least one additional average daily response for the first question of the online survey based on the additional received responses.

7. The electronic device-controlled method of claim 5, further comprising the electronic device adjusting the upper confidence level based on the additional received responses.

8. The electronic device-controlled method of claim 5, further comprising the electronic device adjusting the lower confidence level based on the additional received responses.

9. The electronic device-controlled method of claim 5, further comprising the electronic device determining whether the first question of the online survey is stable based on the at least one additional average daily response in relation to the upper and lower confidence levels.

10. The electronic device-controlled method of claim 1, further comprising the electronic device visually presenting to a user the plurality of average daily responses and the upper and lower confidence levels over the specified period of time.

11. The electronic device-controlled method of claim 5, further comprising an electronic display visually presenting to a user the plurality of average daily responses, the at least one additional average daily response, and the upper and lower confidence levels.

12. The electronic device-controlled method of claim 11, wherein the electronic device includes the electronic display.

13. The electronic device-controlled method of claim 1, wherein the specified period of time is 60 days.

14. The electronic device-controlled method of claim 1, wherein the upper confidence level is a 95% confidence level.

15. The electronic device-controlled method of claim 1, wherein the lower confidence level is a 95% confidence level.

16. The electronic device-controlled method of claim 1, further comprising a user creating the online survey, the online survey including a set of questions from a question repository, each question having a superficial modifier portion, a semantic modifier portion, an open-ended portion, or a combination thereof.
